(19) United States
(12) Patent Application Publication
(10) Pub. No.: US 2026/0146421 A1
(43) Pub. Date: May 28, 2026

(54) Portable Water Dispenser With Integrated Air-To-Water Generation System

(71) Applicant: Kara Water, Inc., New York, NY (US)

(72) Inventors: Cody Soodeen, Stroudsburg, PA (US); Colin Paterson, Carlisle, MA (US); William Irvine, Riverside, CT (US)

(73) Assignee: Kara Water, Inc., New York, NY (US)

(21) Appl. No.: 19/401,573

(22) Filed: Nov. 26, 2025

Related U.S. Application Data
(60) Provisional application No. 63/725,005, filed on Nov. 26, 2024.

(51) Int. Cl. E03B 3/28; A47J 31/60

(52) U.S. Cl. CPC E03B 3/28; A47J 31/605

(57) ABSTRACT

The water dispenser may comprise a housing assembly, a water generation assembly, a water storage assembly, and a water utilization assembly. The water generation assembly may be positioned within the housing assembly and is designed to extract water from the air. In preferred embodiments, the water generation assembly comprises a desiccant system designed to extract moisture from the air and convert it into water using a desiccant. The process typically involves pulling air into the system, where it comes into contact with a desiccant that attracts the moisture. This moisture-laden desiccant is then heated, releasing the water vapor, which is subsequently condensed into liquid water and collected. The water generation assembly utilizes a lateral fan and a custom air duct to direct the air in a lateral flow pattern through the water dispenser. The water storage assembly is mounted to the housing assembly and is adapted to store and sanitize the water collected by the water generation assembly. The water utilization assembly utilizes the sanitized water stored in the water storage assembly for various applications.

### CROSS-REFERENCE TO RELATED APPLICATION

This application claims priority to U.S. Provisional Application No. 63/725,005, filed on Nov. 26, 2024, which is incorporated herein by reference in its entirety.

### BACKGROUND

People typically utilize tap water or bottled water to drink, make ice, make beverages like coffee or tea, and water pets and plants. However, both water sources may introduce contaminants into drinking water. In the United States and abroad, the quality of tap water can vary significantly depending on geographical location, the source of the water, and the effectiveness of local water treatment facilities. Despite regulations and efforts to ensure safe drinking water, some contaminants can still be present in tap water. These contaminants can come from natural sources, industrial processes, agricultural activities, and urban runoff. Known contaminants include microorganisms such as bacteria, viruses, and parasites, chemicals such as chlorine and pesticides, and industrial pollutants such as volatile organic compounds (VOCs) and microplastics. Meanwhile, plastic water bottles can leach various chemicals into the water they contain, especially under certain conditions like exposure to heat, sunlight, or if the bottles are old or reused. At-home filtration systems, such as pitcher filters, offer some mitigation but require frequent maintenance, have limited capacity, and do not always remove all contaminants, leaving consumers seeking alternative solutions.

At-home dehumidifiers have traditionally been used to remove excess moisture from indoor air, improving comfort and preventing mold growth. In recent years, these systems have been adapted to generate potable water by condensing humidity from the air—a process that offers significant benefits in areas with limited access to clean drinking water or where sustainability is a priority. This approach provides a convenient, decentralized source of water without relying on municipal infrastructure or bottled water, making it attractive for residential use.

Conventional portable dehumidifiers typically utilize a centrifugal fan to generate airflow through the machine. Because centrifugal fans exhaust air at a direction perpendicular to the direction air is pulled into the fan, these dehumidifiers typically intake air in the side of the device and exhaust air out of the rear of the device. This configuration requires substantial clearance from walls to prevent airflow obstruction, limiting placement options in confined spaces such as countertops or floors near walls. These constraints make traditional systems impractical for continuous operation in residential environments where space efficiency is critical, such as for producing drinking water or supporting applications involving pets and plants.

The perpendicular airflow design also introduces abrupt changes in airflow direction and velocity, which results in elevated noise levels and contributes to noise pollution. In addition to being noisy, these systems are inefficient at water capture. The airflow disruption reduces exposure of intake air to the desiccant wheel, limiting interaction to only a small portion of the wheel and thereby decreasing overall performance. These shortcomings highlight the need for a quieter, more efficient system that can operate continuously in compact environments.

### SUMMARY

The invention disclosed herein is directed to an automatic water dispenser with an integrated air-to-water generation system. Because air-to-water generation systems are capable of generating the purest forms of water, the water dispenser of the present invention is capable of producing water free from the typical contaminants found in tap and bottled water. The water dispenser of the present invention may incorporate integrated systems to provide potable water for a variety of applications. Additionally, the water dispenser can function in environments where access to traditional water sources is limited.

In an embodiment exemplifying the principles of the invention, the beverage machine may comprise a housing assembly, a water generation assembly, a water storage assembly, and a water utilization assembly. The water generation assembly may be positioned within the housing assembly and is designed to extract water from the air. In preferred embodiments, the water generation assembly comprises a desiccant water generator system designed to extract moisture from the air and convert it into water using a desiccant. Desiccants are substances that naturally attract moisture from the air due to their hygroscopic properties. The process typically involves pulling air into the system, where it comes into contact with a desiccant that attracts the moisture. This moisture-laden desiccant is then heated, releasing the water vapor, which is subsequently condensed into liquid water and collected. The water generation assembly utilizes a lateral fan and a custom air duct to direct the air in a lateral flow pattern straight through the water dispenser.

The water storage assembly comprises a water tank mounted to the housing assembly and is adapted to store and sanitize the water collected by the water generation assembly. For example, a UV sterilization system may be incorporated into the water storage assembly to sanitize the water. The water storage assembly may also optionally include a water filter system, such as a mineral filter. The water tank preferably includes a level sensor adapted to shut off the water generation assembly once the water tank reaches maximum capacity.

The water utilization assembly may comprise a variety of different water-use applications, including an icemaker, a drip coffee machine, a beverage pod machine, a cocktail machine, an auto-refilling pitcher, or an automatic watering system for pets or plants. In any of these applications, the system may be automatically refilled with clean drinking water without prompting by the user. Some embodiments utilize a Wi-Fi module that allows the water dispenser to connect to a local wireless network. Users may connect to the water dispenser through the local wireless network and control the dispenser using a downloadable application on their smartphone. Through the application, users can: (i) monitor water consumption; (ii) set fill rates and refill times; (iii) receive real-time alerts about water levels, filter replacement, etc.; and (iv) adjust settings on the water dispenser, such as placing the water dispenser in various modes (on/off/away).

The above summary is not intended to describe each illustrated embodiment or every possible implementation. These and other features, aspects, and advantages of the present invention will become better understood with regard to the following description, appended claims, and accompanying drawings.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages in accordance with the present invention:

FIG. 1 is a front perspective view of an embodiment of an automatic pet water dispenser incorporating the air-to-water generation assembly of the present invention;

FIG. 2 is an exploded view of the automatic pet water dispenser of FIG. 1;

FIG. 3A is a front perspective view of an exemplary embodiment of the air-to-water generation assembly of the present invention;

FIG. 3B is a front perspective view of the air-to-water generation assembly of FIG. 3A, with the frame removed;

FIG. 3C is a rear perspective view of the air-to-water generation assembly of FIG. 3A, with the frame removed;

FIG. 3D is a front exploded view of the air-to-water generation assembly of FIG. 3A;

FIG. 3E is a rear exploded view of the air-to-water generation assembly of FIG. 3A;

FIG. 4A is a perspective view of an exemplary embodiment of an air duct that may be used in the air-to-water generation assembly FIG. 3A;

FIG. 4B is a perspective view of the air duct of FIG. 4A;

FIG. 5 is an exploded view of an exemplary embodiment of a water sanitization and storage system that may be used in the automatic pet water dispenser of FIG. 1;

FIG. 6 is a front perspective view of an embodiment of a portable beverage dispenser incorporating the air-to-water generation assembly of the present invention;

FIG. 7 is an exploded view of the portable beverage dispenser of FIG. 6;

FIG. 8 is an exploded view of an embodiment of a pod subassembly that may be used in the portable beverage dispenser of FIG. 6;

FIG. 9 is an exploded view of the water storage and sanitization assembly of the portable beverage dispenser of FIG. 6; and

FIG. 10 is a perspective view illustrating the airflow pattern through the portable beverage dispenser of FIG. 6.

### DETAILED DESCRIPTION

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Alternate embodiments may be devised without departing from the spirit or the scope of the invention. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

As used herein, the terms “a” or “an” are defined as one or more than one. The term “plurality,” as used herein, is defined as two or more than two. The term “another,” as used herein, is defined as at least a second or more. The terms “comprises,” “comprising,” or any other variation thereof are intended to cover a non-exclusive inclusion, such that a process, method, article, or apparatus that comprises a list of elements does not include only those elements, but may include, other elements not expressly listed or inherent to such process, method, article, or apparatus. An element proceeded by “comprises” does not, without more constraints, preclude the existence of additional identical elements in the process, method, article, or apparatus that comprises the element. The terms “including,” “having,” or “featuring,” as used herein, are defined as comprising (i.e., open language). The term “coupled,” as used herein, is defined as connected, although not necessarily directly, and not necessarily mechanically. As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. Relational terms such as first and second, top and bottom, right and left, and the like may be used solely to distinguish one entity or action from another entity or action without necessarily requiring or implying any actual such relationship or order between such entities or actions.

“Vertical” or “vertical direction” as used herein means a direction that is generally parallel to Earth's gravitational force. “Horizontal” or “horizontal direction” as used herein means a direction that is generally perpendicular to Earth's gravitational force. As used herein, “generally perpendicular” means forming an angle between 85 degrees and 95 degrees.

A portable water dispenser with an integrated air-to-water generation assembly utilizing a lateral airflow pattern is disclosed herein. The perpendicular airflow pattern of traditional portable dehumidifiers, which intake air in the side of the device and exhaust air out of either the top or rear of the device, creates loud noise pollution due to the abrupt change in airflow direction and velocity. The lateral airflow of the present system minimizes airflow disruption and direction change, thereby significantly reducing the noise pollution created by the system. This system design also increases efficiency of water capture by maintaining the velocity of the air and maximizing the surface area of desiccant exposed to the airflow for water vapor capture. Additionally, traditional systems that exhaust air out of the rear of the device are restricted in how close they can be positioned to a surface behind the device. With a lateral airflow that exhausts out of the side of the device, there is no restriction on the distance the rear of the device must be positioned away from another surface, which allows for more flexible positioning on counter tops or close to walls for use in the home or other confined spaces.

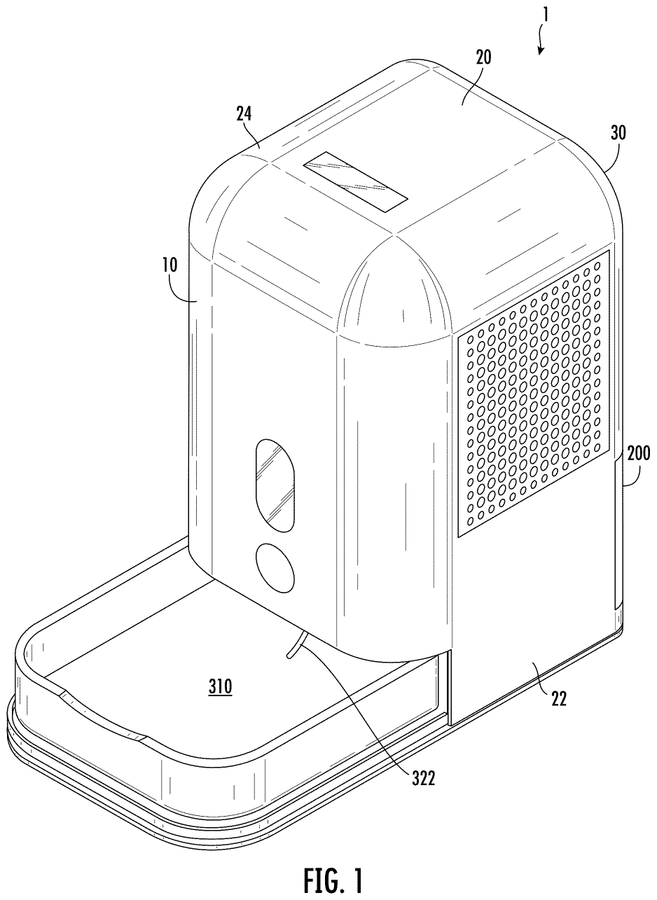

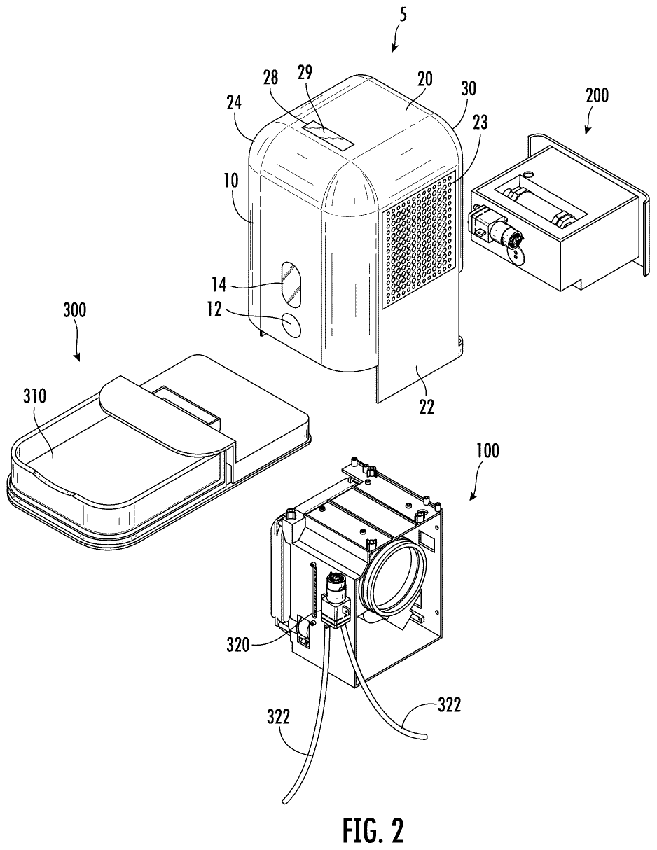

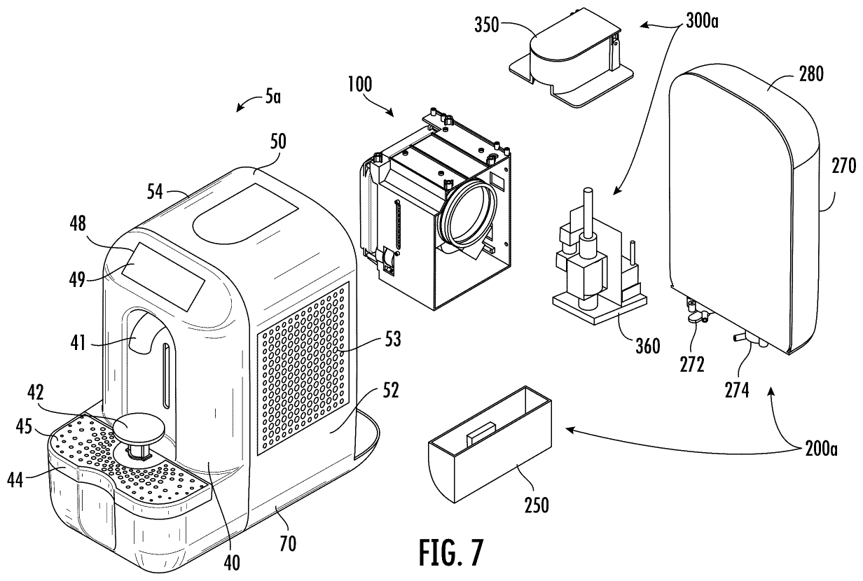

Referring now to FIGS. 1-10, a water dispenser embodying features of the present invention is shown. As shown in FIGS. 2 and 7, the water dispenser 1 may comprise: (1) a housing assembly 5; (2) a water generation assembly 100 positioned within the housing assembly 5 and designed to extract water from the air; (3) a water storage assembly 200 mounted to the housing assembly 5 for sanitizing and storing the water collected by the water generation assembly 100; and (4) a water utilization assembly 300 positioned within the housing assembly 5 and adapted to utilize the sanitized water stored in the water storage assembly 200.

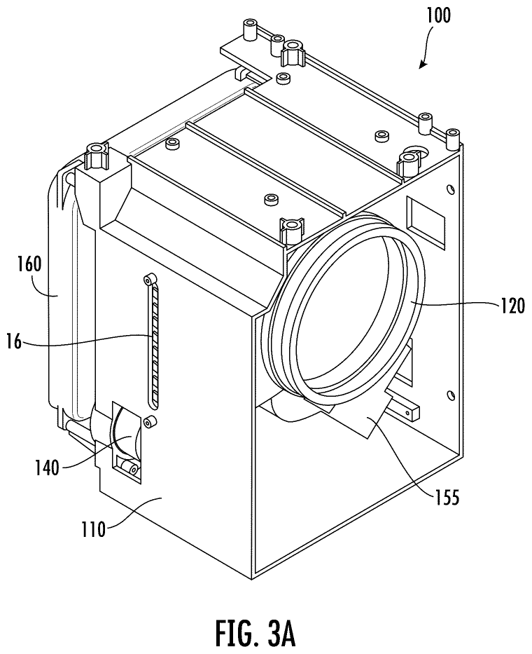

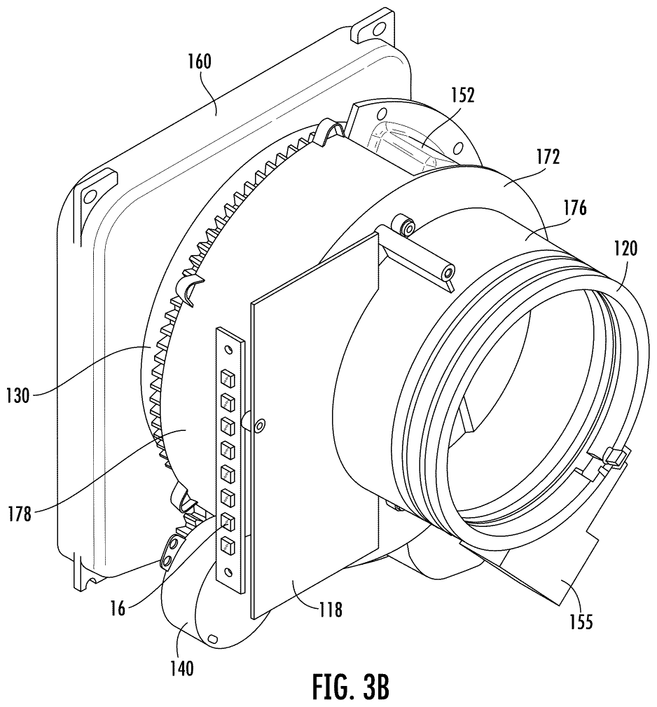

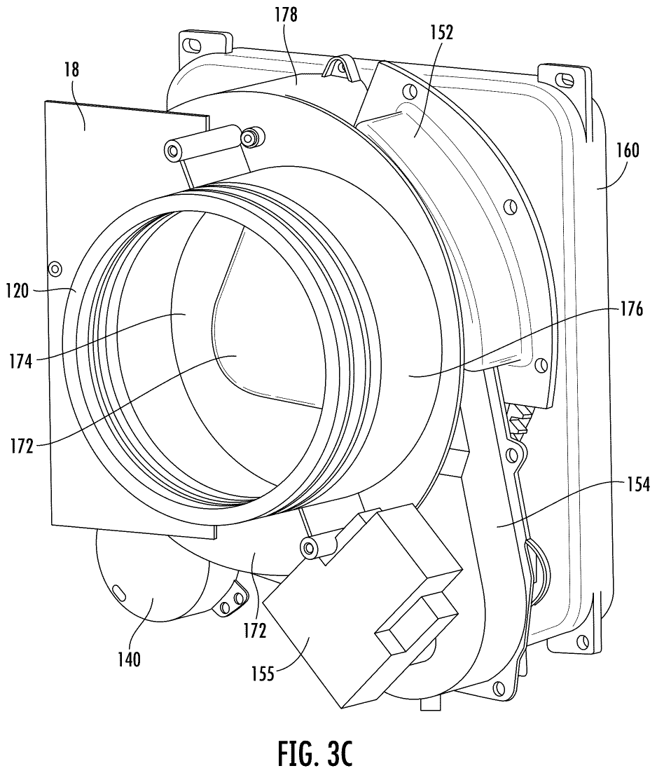

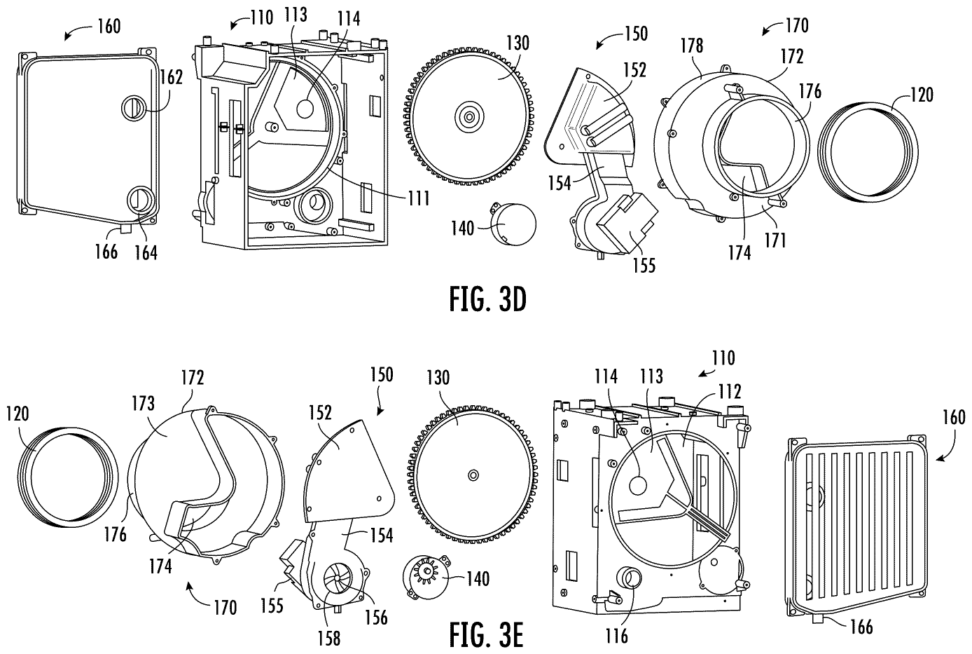

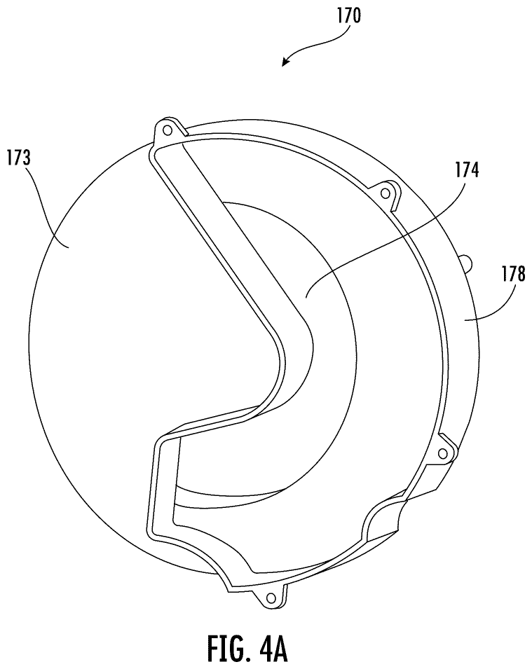

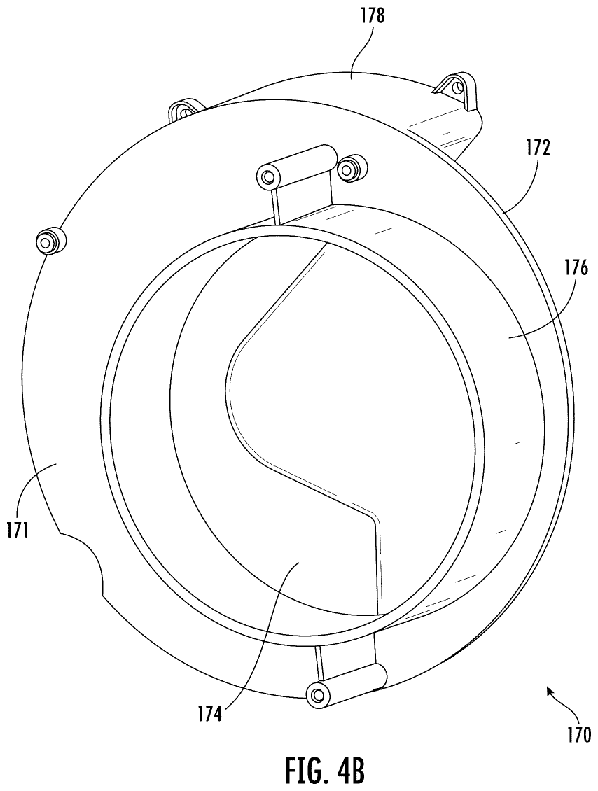

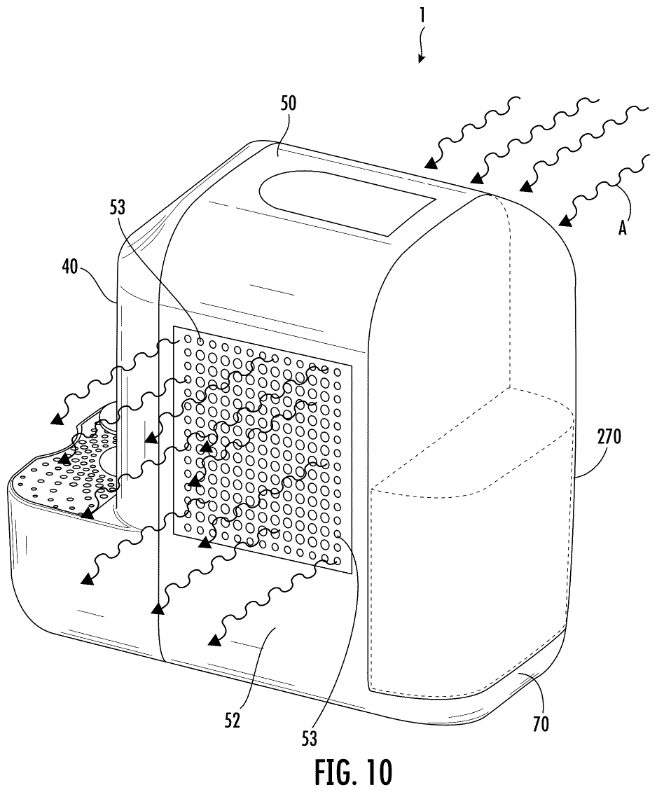

Referring now to FIGS. 3A-4B, the water generation assembly 100 may comprise: a frame 110, a fan 120, a desiccant wheel 130, a motor 140, a heater 150, a water condenser tank 160, and an air duct 170. The desiccant wheel 130 is coated or compounded with a desiccant, which can be Zeolite, silica gel, or any other hygroscopic substance that has a high affinity for water molecules. The fan 120 preferably is a lateral fan powered by a fan motor (not pictured). While typical portable desiccant systems use centrifugal fans that exhaust the dehumidified air out at a 90-degree angle from the angle at which the air enters the fan, the water generation assembly 100 of the present invention has been adapted to employ a lateral fan 120 so that the air is exhausted out of the system in the same direction of flow that it was pulled into the system. This airflow pattern is illustrated as airflow A in FIG. 10. While lateral fans have not been incorporated into dehumidification systems in the past because they could not generate sufficient airflow to operate efficiently, the air-to-water generation system 100 of the present invention utilizes a uniquely designed air duct 170 that magnifies the strength of the lateral fan and allows the water dispenser 1 to utilize a lateral airflow pattern.

Turning to FIGS. 3D-3E, the frame 110 comprises a desiccant wheel chamber 111, which includes a covered portion 113, an uncovered portion 112, and a first aperture 114 positioned in the covered portion 113 of the desiccant wheel chamber 111; and a heater fan chamber 115 with a second aperture 116 positioned in the heater fan chamber 115. When the desiccant wheel 130 is situated within the wheel chamber 111, the wheel 130 is rotated by motor 140. The covered portion 113 of the wheel chamber 111 shields approximately one-third of the desiccant wheel 130 as it rotates within the wheel chamber 111. On the opposite side of the desiccant wheel 130, the heating element 152 of the heater unit 150 aligns with the covered portion 113 of the wheel chamber 111, and the air duct 170 aligns with the uncovered portion 112 of the wheel chamber 111. The region of the desiccant wheel 130 situated between covered portion 113 and heater unit 150 at any given moment is the regeneration region, where captured moisture is evaporated from the wheel 130. The remaining portion of the desiccant wheel 130 is the process region, or moisture-attracting region of the wheel.

As shown in FIGS. 4A-4B, air duct 170 comprises a flat disk base 172 with a first side 171 and a second side 173, a first shroud 176 protruding from the first side 171, and a second shroud 178 protruding from the second side 173. The first shroud 176 mates with fan 120, while the second shroud 178 faces the desiccant wheel 130. Where the first shroud 176 and the second shroud 178 overlap, there is an opening 174 in the disk 172 that allows airflow to be pulled through the duct 170. The shape of the air duct 170 is designed to magnify the force of the airflow generated by the lateral fan 120 and to specifically direct the airflow through the process region of the desiccant wheel 130. To accomplish this, the first shroud 176 is shaped to correspond to the shape of the fan 120—in the depicted embodiment, a circle—and the second shroud 178 is shaped to correspond to the shape of the process region of the wheel 130. Thus, in the depicted embodiment where the heating element 152 is shaped like a circular sector, and therefore the process region of the wheel 130—defined by the area that is not covered by the heating element 152—is roughly crescent-shaped, the shroud 178 is crescent-shaped. However, in other embodiments utilizing different geometry for the regeneration region and process region of the desiccant wheel, the shrouds 176, 178 could be shaped differently to accommodate this variable geometry. When the fan 120 turns on and starts to pull air in towards the water generation assembly 100, the circular shroud 176 immediately limits the area the fan's force can be directed in order to maximize the strength of the suction. Then, opening 174 and crescent shroud 178 target the force of the air suction to maximize airflow around the heating element 152 and through the process portion of the wheel 130.

Turning back to FIGS. 3A-3E, the heater unit 150 comprises heating element 152 and a heater fan 156 situated inside a duct 154 that connects the heater fan 156 to the heating element 152. The duct 154 comprises a heater inlet 158 over the fan that aligns with the second aperture 116 of the frame 110 when the heater duct 154 is situated within the heater fan chamber 115. The heater unit 150 also comprises an electric motor 155, which powers the heating element 152. On the opposite side of the frame 110, the water condenser tank 160 is a hollow body that comprises an air inlet 162 that aligns with the first aperture 114 of the frame 110, an air outlet 164 that aligns with the second aperture 116 of the frame 110, and a water outlet 166 situated in the bottom face of the water condenser tank 160.

Viewing FIGS. 3A-4B together, the working principle of the water generation assembly 100 is described below. The fan 120 creates an external airflow pattern that pulls ambient air through the airflow apertures 23 in the left side panel 24 of housing 5 and into the water generation assembly 100. The air passes the exterior of the water condenser tank 160, through the uncovered portion 112 of the desiccant wheel chamber 111 of frame 110, and then through the process region of the desiccant wheel 130, where the desiccant material of the wheel 130 captures the water vapor as the air passes through the wheel 130. Once through the wheel 130, the dehumidified air passes through the crescent shroud 178, through the opening 174, and then through the circular shroud 176 of the air duct 170. The air then travels through the lateral fan 120 and is finally exhausted out of the device through the airflow apertures 23 in the right-side panel 22 of the housing 5.

Meanwhile, a second, internal airflow is circulated through the system 100. The heater fan 156 drives the internal airflow through the heating element 152, then through the regeneration region of the desiccant wheel 130, where the warm air heats the water captured by the desiccant wheel 130 to the point of vaporization. The humidified air then flows through the first aperture 114 of frame 110 and into air inlet 162 of the water condenser tank 160. In the water condenser tank 160, the humidified internal air is cooled by the exterior airflow being pulled past the exterior of the water condenser tank 160 by the lateral fan 120, causing the water vapor in the humidified air to condense inside the water condenser tank 160. The water then pours out of the water outlet 166 into the water storage and sanitization assembly 200. Meanwhile, as the cool, dehumidified air naturally falls to the bottom of the water condenser tank 160, it is pulled out by the heater fan 156 through the air outlet 164 of the water condenser tank 160, through the second aperture 116 of the frame 110, and back through the heater inlet 158 into the duct 154 of the heater unit 150, where it is recycled through the heating element 152 to become warm airflow for regenerating the desiccant wheel 130. Because the wheel 130 is constantly rotated by the motor 140 while desiccant wheel assembly 100 is producing water, a saturated portion of the wheel 130 is always entering the regeneration region, where it is dried and then rotated out of the regeneration region and back into the process region, ready to capture more water from the incoming ambient air again.

### Pet Water Dispenser

Referring to FIGS. 1-2 and 5, an exemplary embodiment of a water dispenser that can integrate the water generation assembly of the present invention is shown. In this embodiment, the water dispenser 1 is an automatic pet water dispenser. The housing assembly 5 of the pet water dispenser 1 is shown in FIGS. 1-2. In the depicted embodiment, the housing assembly 5 is a plastic enclosure made up of individual plastic components that connect together to create a complete enclosure for the water generation assembly 100. In the depicted embodiment, the housing assembly 5 comprises a front housing panel 10, a central shell 20, and a rear housing panel 30. Front housing panel 10 may comprise a window 14 for an LED light display 16 to provide the user with easily readable information about the system. In some embodiments, front housing panel 10 may also incorporate a camera 12 and/or a speaker to allow a user to visually monitor their pet remotely and speak to their pet. Front housing panel 10 acts as a receptacle with an opening or channel adapted to receive the water basin constituting the water utilization assembly 300. The central shell 20 of the automatic pet water dispenser 1 features right and left side housing panels 22, 24 having airflow apertures 23 to enable air flow into and out of the water generation assembly 100. The rear housing panel 30 acts as a receptacle with an opening or channel adapted to receive the water storage drawer 210 of the water storage assembly 200. The housing assembly 5 may comprise hooks or any other suitable mechanism designed for releasable connection to water storage drawer 210 and water basin 300.

The functionality of the pet water dispenser 1 is managed by a central controller, which may comprise a control panel 18 coupled to one or more printed circuit boards (PCBs) storing programming modules that allow a user to control the dispenser's functions, such as the ability to turn the dispenser on and off, set dispensing schedules, control the camera, etc. In some embodiments, pet water dispenser 1 may utilize a button for user input, but other embodiments may use an LCD control touch screen 29 connected to a screen controller PCB. When a button is used, central shell 20 may comprise a button aperture, and when an LCD control touch screen 29 is used, central shell 20 may comprise a touch screen display window 28 instead. These control elements are merely exemplary of the many elements of a control system that a skilled artisan would readily recognize as being useful in pet water dispenser 1.

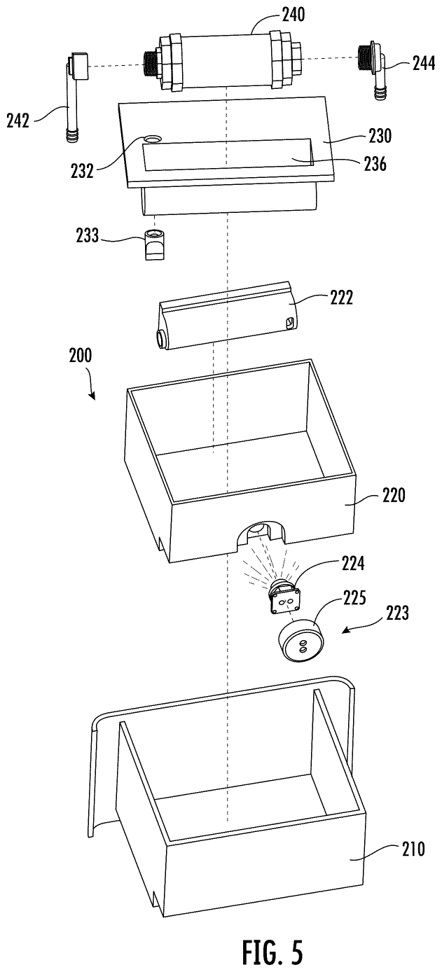

Referring to FIGS. 2 and 5, the water storage assembly 200 may comprise a drawer 210, a storage tank 220, and a lid 230. The lid 230 includes sensors that detect when the lid 230 is in place on the storage tank 220. Inside the storage tank 220 is a water level sensor, which detects the level of water in the tank 220 and reports the water level to the user via LED PCB 16 visible through the window 14 in front housing 10. If the tank is full, the control panel 18 automatically shuts down the water generation assembly 100 so that storage tank 220 does not overflow. The water storage tank 220 comprises a sanitization subassembly 223 that sanitizes the water while it is stored in the storage tank 220. In the exemplary embodiment depicted in the Figures, the sanitization subassembly comprises a UV water treatment system, but a skilled artisan will recognize that this is just one of many sanitization systems that may be employed in the present invention. The water sanitization subassembly 223 comprises a UV LED lamp 224 that sanitizes the water inside water storage tank 220. The UV lamp 224 is seated on UV lamp adapter PCB 225, which is covered by a plastic cap that leaves only two contact plates visible. When the tank 220 is properly seated, the contacts on the UV adapter board 225 touch spring-loaded contacts on a PCB seated in drawer 210. Once the control panel 18 registers the tank's 220 placement, the UV LED lamp 224 is automatically activated according to an algorithm, which only allows the UV LED 224 to turn on when the tank 220 is in place and the lid 230 is secured on top so as not to expose the user to UV light. The tank 220 and lid 230 are preferably formed of opaque material, both to protect the user from exposure to UV light and to protect the stored water from exposure to external light sources that can reactivate any biological contaminants that were neutralized by the UV light.

Lid 230 comprises an aperture 232 with an inlet 233 that connects to the water outlet 166 of the water condenser tank 160. Lid 230 also comprises a recess 236 that houses a water filtration system 240. The recess 236 comprises two apertures that allow the water filtration system's 240 inlet valve 242 and outlet valve 244 to enter the storage tank. Inside storage tank 220 is a pump 222 that circulates the water in the tank 220 towards the inlet valve 242 of the water filtration system 240. The drawer 210 comprises a handle that allows the user to easily remove the drawer 210 from the housing 5 to clean and replace the filters.

The water utilization assembly 300 of the pet water dispenser 1 is a water basin assembly. The water basin assembly 300 may comprise a drinking bowl 310, a level sensor coupled to the drinking bowl, a shut-off valve designed to restrict the water level in the drinking bowl, and a releasable lock mechanism to allow users to remove and replace the drinking bowl as needed to clean the bowl. The automatic pet water dispenser 1 may also include food and medicine dispensers integrated into the utilization assembly 300. When the control panel 18 receives input that the water level is low, it turns on the pump 222 in the storage tank 220 to pump water into the filtration system 240 and a second pump 320 which pulls water from the outlet 244 of the water filtration system 240 and then dispenses the freshly filtered water out through tubing 322 into the drinking bowl 310.

### Beverage Dispenser

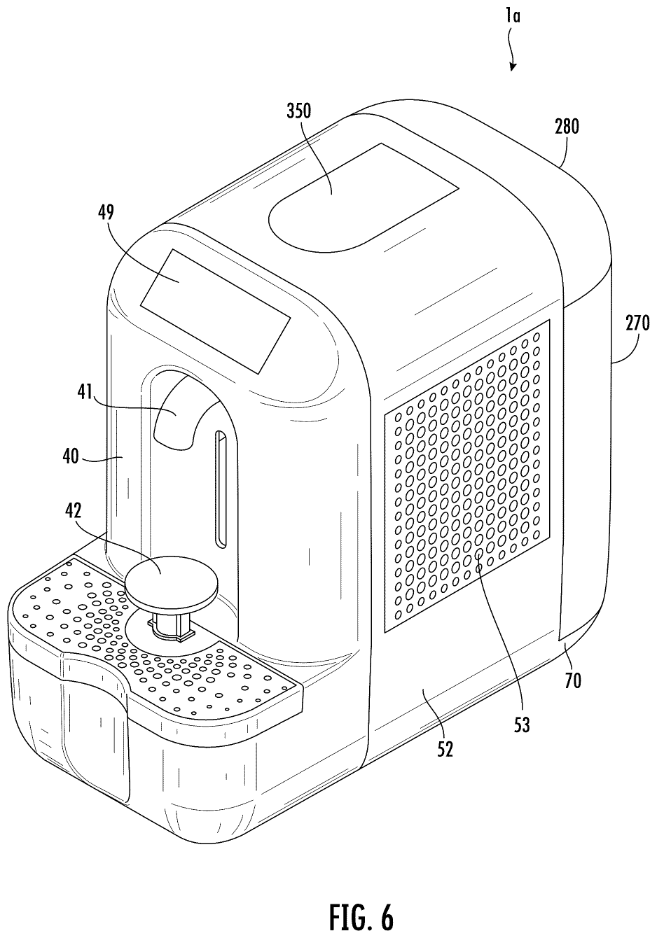

Referring now to FIGS. 6-10, a second exemplary embodiment of a water dispenser that can integrate the water generation assembly 100 of the present invention is shown. In this embodiment, the water dispenser 1 is a portable beverage machine 1a. The housing assembly 5a of the beverage dispenser 1a is shown in FIGS. 6 and 7. In the depicted embodiment, the housing assembly 5a comprises a front housing 40, a central shell 50, a rear housing 60, and a bottom housing 70. Front housing 40 comprises a spout 41 through which the freshly brewed beverage is poured, a height-adjustable cup plate 42 on which the user can place a cup to receive the beverage poured from the spout 41, a drip tray 44 surrounding cup plate 42, and a grate 45 covering drip tray 44. The height of the cup plate 42 may be adjusted by a spring-loaded press-release mechanism, or by any other suitable means known in the art or developed in the future. The central shell 50 of beverage dispenser 1a features right and left side housing panels 52, 54 having airflow apertures 53 to enable air flow into and out of the water generation assembly 100. Rear housing 60 (shown in FIG. 9) comprises a vertical panel 62 that separates the central shell 50 from the water storage tank 270 and a horizontal panel 64 that separates the bottom housing 50 from the water storage tank 270. The vertical panel 62 may comprise hooks or any other suitable mechanism designed for releasable connection to water storage tank 270. Bottom housing 70 generally comprises a hollow shell. One side of bottom housing 70 may include a slot (not pictured) for a filter chamber 250 to fit.

The functionality of the beverage dispenser 1a is managed by a central controller (not pictured), which may comprise a control panel coupled to one or more printed circuit boards (PCBs) storing programming modules that allow a user to control the dispenser's functions, such as the ability to turn the dispenser on and off, set the brew strength, program brewing schedules, etc. In some embodiments, beverage dispenser 1a may utilize a button for user input, but other embodiments may use an LCD control touch screen 49 connected to a screen controller PCB. When a button is used, front housing 40 may comprise a button aperture, and when an LCD control touch screen 49 is used, front housing 40 may comprise a touch screen display window 48 instead. Additionally, some embodiments of beverage dispenser 1a may feature an LED PCB with indicator lights visible through a window 46 in front housing 40. These control elements are merely exemplary of the many elements of a control system that a skilled artisan would readily recognize as being useful in beverage dispenser 1a.

Turning now to FIGS. 7 and 9, the generated water next enters the water storage assembly 200a. After the water condenses in the water condenser tank 160, it exits through water outlet 166 and enters filter chamber 250, which comprises one or more filters that remove any particulates or contaminants in the water. The filters may be carbon filters, mineralization filters, or any other high-filtration components. The filter chamber 250 comprises a handle that allows the user to easily remove the filter chamber 250 from the bottom housing 70 to clean and replace the filters. The filter chamber 250 may have a water level sensor operatively connected to the control panel such that when the sensor detects that the filter chamber 250 is full, the control panel automatically prompts a water pump to pump the filtered water from the filter chamber 210 into storage tank 270 through inlet valve 272.

Storage tank 270 may comprise an inlet valve 272, through which water enters storage tank 270 from filter chamber 250; and an outlet valve 274, through which water exits storage tank 270 to make a beverage at beverage generation assembly 300a. In some embodiments, the tank 270 may be connected to a second outlet valve, through which water exists storage tank 270 and is carried directly to spout 41. In this embodiment, the spout 41 comprises two separate channels—one for pure water and one for beverages generated in the generation assembly 300a. Once storage tank 270 is seated on rear housing 60, a removable lid 280 may be placed on top of the tank 270. The lid 280 includes sensors that detect when the lid 280 is seated properly on the tank 270. For example, the depicted embodiment comprises a magnet 282 on tank lid 280 that engages a magnet sensor positioned on the horizontal panel 64 of rear housing 60, but a skilled artisan would recognize that this is merely illustrative of the many sensor systems that are suitable for this purpose. Inside storage tank 270 is a water level sensor, which detects the level of water in the tank 270 and may report the level to the user via the LED light display or via LCD touch screen 49. If the tank is full, the control panel automatically shuts down the water generation assembly 100 so that storage tank 270 does not overflow.

The water storage assembly 200a further comprises a sanitization subassembly 276 that sanitizes the water while it is stored in the storage tank 270. In the exemplary embodiment depicted in the Figures, the sanitization subassembly comprises a UV water treatment system, but a skilled artisan will recognize that this is just one of many sanitization systems that may be employed in the present invention. A UV LED lamp 277 is positioned within tank 270 and is seated on UV lamp adapter PCB 278 positioned beneath the tank 270. The UV lamp adapter PCB 278 is covered by a plastic cap that leaves only two contact plates visible. When the tank 270 is properly seated on the rear housing 60, the contact points on the UV lamp adapter PCB 278 touch spring-loaded contact prongs protruding from a control PCB positioned within the bottom housing 70 beneath the tank 270. Once the control PCB registers the tank's 270 placement, the UV LED lamp 277 is automatically activated according to an algorithm, which only allows the UV LED to turn on when the tank 270 is in place and the lid 280 is secured on top so as not to expose the user to UV light. The tank 270 and lid 280 are formed of opaque material, both to protect the user from exposure to UV light and to protect the stored water from exposure to external light sources that can reactivate any biological contaminants that were neutralized by the UV light. In some embodiments, the control panel may direct a signal either to the LED PCB or to the LCD control touch screen 49 when it registers that the water in the tank has been adequately sanitized based on input from the water level sensor.

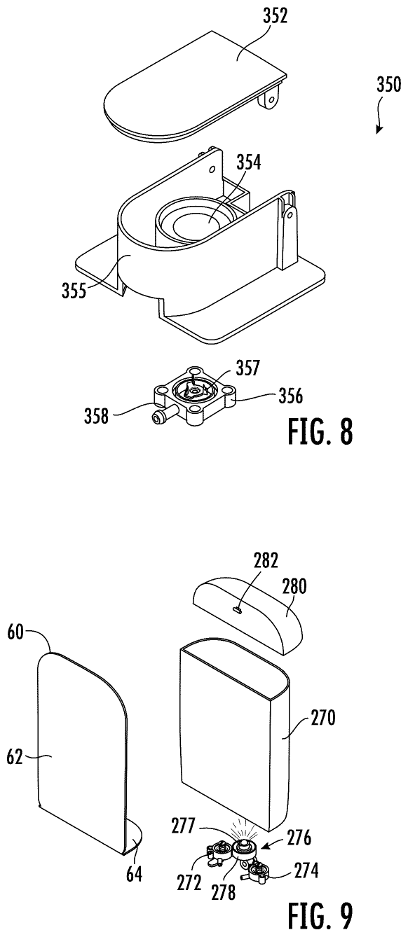

After the generated water has been filtered and sanitized, it must pass through the beverage generation assembly 300a when the user prompts dispenser 1a to prepare a beverage. Turning to FIGS. 7 and 8, beverage generation assembly 300a may comprise a pod subassembly 350 and a heater subassembly 360. An exemplary embodiment of pod subassembly 350 is shown in FIG. 8. The pod subassembly 350 comprises a pod vehicle 354, a lid 352 operably connected to the pod vehicle 354 using a hinge connection, and a beverage collection basin 356. To insert a pod, the user presses down on the lid 352, which releases the lock by a push-down spring mechanism and allows the lid 352 to raise, exposing the pod vehicle 354 underneath. The user can then insert the pod into the pod compartment 355, shaped to correspond to a standard beverage pod, in the pod vehicle 354. When the lid 352 is pushed closed, the pod is forced down onto puncture prongs 357 in the beverage collection basin 356, which puncture the bottom of the pod. At the same time, the aluminum or paper top of the pod is punctured by spikes on the underside of the lid 352, exposing the flavor contents inside the pod. The lid 352 also comprises a water inlet that directs water pumped from the heater subassembly 360 through apertures that correspond in location to the spikes such that the water flows through the puncture holes in the top of the pod. The beverage collection basin 356 positioned at the bottom of the pod vehicle 354 comprises a water outlet 358 that directs the beverage released from the bottom of the pod out to the spout 41. This pod assembly is merely exemplary of the many different configurations of pod assemblies, both known in the art and developed in the future, that can be used in connection with the water generation system 100 of the present invention. In addition, the water generation, purification, and storage systems of the present invention may be incorporated into traditional drip coffee makers, or any other device that produces liquid-based consumables.

When the user initiates the brewing process after inserting a pod into the pod subassembly, water is pumped from storage tank 270 through heater subassembly 360 up to pod subassembly 350. After it has been heated in the heater subassembly 360, the hot water is forced through the pod under pressure in the pod subassembly 350. The beverage dispenser 1a optimizes the water temperature and pressure depending on the beverage being produced and the preferences input by the user. As the hot water passes through the pod, it dissolves and extracts the soluble compounds from the pod contents. Viewing FIGS. 6 and 7, the beverage exits through spout 41 in front housing 40 and is poured into the waiting cup sitting on cup plate 42 below. In some embodiments, after the beverage has been poured, the empty pod may be discarded through a used pod duct into a used pod receptacle. The used pod receptacle may be removable and comprise an external handle so that the user may access the receptacle when it is full and remove the used pods.

Although certain detailed embodiments are disclosed above, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Alternate embodiments may be devised without departing from the spirit or the scope of the invention. Further, the terms and phrases used herein are not intended to be limiting, but rather, to provide an understandable description of the invention. While the specification concludes with claims defining the features of the invention that are regarded as novel, it is believed that the invention will be better understood from a consideration of the forgoing description in conjunction with the drawing figures, in which like reference numerals are carried forward.

What is claimed is:

1. A water dispenser comprising:
a) a housing assembly;
b) an air-to-water generation assembly positioned within the housing assembly and
adapted to utilize a lateral airflow pattern for water generation; and
c) a water storage assembly mounted to the housing assembly configured to store and sanitize the water collected by the water generation assembly.

2. The water dispenser of claim 1, wherein the air-to-water generation assembly comprises:
a) a frame;
b) a desiccant wheel mounted to the frame for adsorbing water from ambient air;
c) a heater unit positioned adjacent to a regeneration section of the desiccant wheel;
d) a water condenser tank connected to the frame for collecting condensed water.

3. The water dispenser of claim 2, wherein the air-to-water generation assembly further comprises a motor secured to the frame and configured to rotate the desiccant wheel.

4. The water dispenser of claim 3, wherein the air-to-water generation assembly further comprises a lateral fan.

5. The water dispenser of claim 4, wherein the air-to-water generation assembly further comprises an air duct; wherein the air duct is secured to the lateral fan by a first shroud operatively coupled to the fan; wherein the air duct is secured to the frame by a second shroud operatively coupled to a process section of the desiccant wheel; and wherein an area of overlap between the first shroud and the second shroud defines an opening in the airduct.

6. The water dispenser of claim 2, wherein the heater unit is secured to the frame and comprises: (i) a heating element covering a regeneration section of the desiccant wheel; and (ii) a heater duct operatively coupling the heating element to a heater fan.

7. The water dispenser of claim 2, wherein the water condenser tank comprises an inlet configured to intake air from the regeneration section of the desiccant wheel and an outlet configured to exhaust air into the heater duct.

8. The water dispenser of claim 1, wherein the water storage assembly comprises:
a) a storage tank;
b) a water filtration system configured to filter impurities from condensed water
received from the air-to-water generation assembly; and
c) a water sanitization subassembly configured to sanitize condensed water received from the air-to-water generation assembly.

9. The water dispenser of claim 8, wherein the storage tank comprises a water level sensor operatively connected to a printer circuit board (PCB); wherein the PCB is operatively connected to a control panel positioned within the housing assembly; wherein the control panel is configured to shut off the air-to-water generation assembly if the tank is full.

10. The water dispenser of claim 8, wherein the water sanitization subassembly comprises a UV light positioned within the storage tank and operatively connected to a printer circuit board (PCB); wherein the PCB, when the tank is mounted in the housing assembly, is configured to operatively connect to a control panel positioned within the housing assembly.

11. The water dispenser of claim 10, wherein the water storage assembly further comprises a lid for the storage tank; wherein the lid comprises a magnet that corresponds to a sensor; wherein the sensor is operatively connected to a control panel positioned within the housing assembly; wherein the control panel is configured not to allow the UV light to turn on unless the PCB is operatively connected to the control panel and the magnet is operatively connected to the sensor.

12. The water dispenser of claim 1, further comprising a beverage generation assembly adapted to utilize the sanitized water stored in the water storage assembly to produce beverages.

13. The water dispenser of claim 12, wherein the beverage generation assembly comprises:
a) a pod subassembly; and
b) a heater subassembly comprising a pump for transmitting water from the water storage assembly to the heater subassembly and from the heater subassembly to the pod subassembly.

14. The water dispenser of claim 13, wherein the pod subassembly comprises:
a) a pod compartment configured to receive a beverage pod;
b) at least one puncture element adjacent to the pod compartment; and
c) a beverage collection basin situated beneath the pod compartment and fluidly coupled to an outlet of the pod subassembly.

15. The water dispenser of claim 1, further comprising a pet watering bowl adapted to utilize the sanitized water stored in the water storage assembly to automatically fill the watering bowl.

16. The water dispenser of claim 15, wherein the pet watering bowl comprises a water level sensor operatively connected to a printer circuit board (PCB); wherein the PCB is operatively connected to a control panel positioned within the housing assembly; wherein the control panel is configured to control the function of a pump for transmitting water from the water storage assembly to the water basin depending on feedback from the water level sensor.
